(19) United States
(12) Patent Application Publication
(10) Pub. No.: US 2012/0279637 A1
(43) Pub. Date: Nov. 8, 2012

(54) Method for producing an adhesive tape intended more particularly for wrapping cables, comprising an open textile carrier and a pressure-sensitive adhesive coated on one side thereof

(75) Inventors: Michael Siebert, Schenefeld (DE); Nicolai Böhm, Hamburg (DE); Dennis Seitzer, Hamburg (DE); Michel Mies, Hamburg (DE); Brigitte Korthals, Hamburg (DE); Lars Guldbrandsen, Glinde (DE); Fabian Günzler, Offenburg (DE)

(73) Assignee: tesa SE, Hamburg (DE)

(21) Appl. No.: 13/456,613

(22) Filed: Apr. 26, 2012

(30) Foreign Application Priority Data
May 3, 2011 (DE) 10 2011 075 160.2

(51) Int. Cl. B05D 5/10; B32B 37/12

(52) U.S. Cl. 156/185; 427/208.4

(57) ABSTRACT

A method produces an adhesive tape having a textile carrier and a pressure-sensitive adhesive coated on one side thereof. A shear viscosity of the pressure-sensitive adhesive, at a temperature of 25° C. during coating from dispersion, is 200 to 100 000 Pa*s at a shear rate of 10⁻² s⁻¹ and is 0.1 to 10 Pa*s at a shear rate of 100 s^{-1.}

The invention pertains to a method for producing an adhesive tape intended more particularly for wrapping cables, and comprising an open textile carrier and a pressure-sensitive adhesive coated on one side thereof.

Adhesive tapes have long been used in industry for producing cable looms. In this case, the adhesive tapes serve for the bundling of a multiplicity of electrical leads, prior to installation or in the ready-mounted state, in order to reduce, by bandaging, the space taken up by the bundle of leads, and additionally to obtain protective functions.

The testing and classifying of adhesive tapes for cable jacketing takes place in the motor-vehicle industry in accordance with extensive bodies of standards such as, for example, LV 312-1 “Protection systems for wire harnesses in motor vehicles, adhesive tapes; test guideline” (10/2009), as a joint standard of the companies Daimler, Audi, BMW and Volkswagen, or the Ford specification ES-XU5T-1A303-aa (revised version September 2009) “Harness Tape Performance Specification”. In the text below, these standards are referred to in abbreviated form as LV 312 and as the Ford specification, respectively.

The sound-damping effect, abrasion resistance and temperature stability of an adhesive tape are determined on the basis of defined test systems and test methods, as described comprehensively in LV 312.

Cable-wrapping tapes with film-based carriers and textile carriers are widespread, and are generally coated on one side with various pressure-sensitive adhesives (PSAs).

On commercial cable-wrapping tapes, the PSAs are based on natural and synthetic rubber and on polyacrylic esters (polyacrylates). On account of the chemical instability of the two first-mentioned examples, there is agreement within technical circles that the demanding temperature classes can be realized only with PSAs based on polyacrylates. Present on the market are cable-wrapping tapes with PSAs based on UV-crosslinkable polyacrylates. These PSAs are placed in the form of a melt onto the textile carrier, by means of a slot die, for example, the coated carrier is cooled, and the required cohesion is brought about by UV radiation in a defined dose. As a result of the viscosity of the melt, the wetting of the textile carrier is often limited and hence adhesive anchorage is not always sufficient, meaning then that an unwanted partial transfer of the PSA to the reverse of the adhesive tape is observed on unwinding.

Alternatives include, in principle, polyacrylates from organic solution or from aqueous dispersion. When open textile carriers are coated with an organic solution using, for example, a comma bar or a coating knife, there is generally strikethrough of the coating solution with the viscosities as possessed by commercial products. The resultant procedural disruptions to coating, the stickiness of the reverse, and the increased level of unwind force are unacceptable.

With commercial acrylate dispersions on open textile carriers, the observations of the experimenter are the same: the dispersion strikes through from the coating side to the reverse. The consequences are the same as from organic solution.

Addressing the presently known patent literature, one does learn that cable-wrapping tapes can be produced with PSAs from an aqueous presentation form. This literature, however, offers little useful in terms of practical advice.

EP 1 132 927 B1 encompasses the use of acrylate compositions in bandaging tapes for cables. Among the carriers embraced by the description are all textile carriers. There is express mention of an acrylate compound which can be coated as an aqueous system. The description says that compounds are ready-to-process mixtures of polymers with the corresponding additives. There is no information at all on how the coating operation is to be performed.

According to EP 0 994 169 B1, crosslinking is often necessary in order to achieve sufficient cohesion (in this case in the sense of chemicals resistance). This in turn leads in general to a reduction in bond strength and tack. The solution lies in a method for producing adhesive tapes by radiation crosslinking, producing effective cohesion in conjunction with a consistently high bond strength. There is disclosure to the effect that the adhesives may also be resin-blended acrylates from dispersion. As in EP 1 132 927 B1 as well, no concrete assistance with realization is given.

DE 44 19 169 A1 describes a flame-retarded tape for cable jacketing where both the carrier and the adhesive comprise flame retardants. Example 1 explicitly mixes an adhesive from the raw materials Primal PS 83 D, Snowtack SE 380 A and flame retardant. Indeed, the use of a thickener “for raising the viscosity” is mentioned. It is notable here that a transfer process is described. The disclosure content does refer to drying the coated fabric in suspension at specific temperatures, but nevertheless the process in the sense of the teaching of the patent is a transfer coating process. Relative to direct coating, this coating process has a range of disadvantages, which are not accepted without reason. Firstly, adhesive anchorage in the case of transfer coating to a woven fabric is generally inadequate. Secondly, transfer coating is a process which is typically employed when the carrier has inadequate processing qualities. Furthermore, in the case of cable-wrapping tapes, a liner is unusual, and thus has the function of a processing aid which is utilized only for the production process. Consequently it gives rise to additional costs, which would normally be avoided. The teaching from this prior art can therefore be interpreted to mean that dispersions cannot be used readily for direct coating. In example 2, in contrast to example 1, an acrylate bead polymer is coated directly. In contradistinction to acrylate dispersions, they are produced by the method of suspension polymerization rather than by the method of emulsion polymerization. The particle diameter of the bead polymers, at about 0.01 to 0.5 mm, is greater by a factor of approximately 100 than that of the acrylate dispersions (on this point, compare Chemielexikon Rompp, entry heading Suspension polymerization (document identifier RD-19-05062, inclusion in the database: March 2002)). It is understandable that these beads, in the order of magnitude of textile pores, are seated in the latter and hence can be coated directly without massive strikethrough through the fabric.

EP 2 000 516 A1 describes an adhesive tape, more particularly a cable-wrapping tape, for motor-vehicle engineering, having a tapelike carrier which is composed of woven fabric and is provided on at least one side with a self-adhesive layer which consists of a pressure-sensitive adhesive, the carrier being given a flexural stiffness of not more than 6 mN/cm² by a number of warp threads in the fabric of the carrier in the range from 20 to 42 per cm and a number of weft threads in the fabric of the carrier in the range from 10 to 22 per cm. The overall disclosure content is aimed at the mechanical properties of this fabric that are associated with this fabric construction. The adhesive is arbitrary.

EP 1 074 595 B1 discloses an adhesive tape comprising a carrier woven from threads which at least authoritatively consist of polyester fibres, of which some extend in the longitudinal direction of the tape and the others transverse thereto, and a layer of adhesive covering at least one side of the carrier, the linear density of the longitudinal threads per unit width of the tape being less than the linear density of the transverse threads per unit length of the tape and not more than 2500 dtex/cm, where the carrier has between 30 and 50 longitudinal threads per centimetre width and between 18 and 27 transverse threads per centimetre length, and the longitudinal threads are fixed in their place by the adhesive in transverse direction, thus giving the tape a transverse-direction tensile strength of less than 10 N.

From EP 1 081 202 A1 it is known that one way of producing an adhesive tape is to apply an acrylate dispersion to a textile carrier in such a way that the resulting depth of immersion into the textile carrier is between 10 μm and 0.5 mm.

However, the disclosure leaves entirely open the specific way in which this depth of penetration can be brought about. The viscosity of the adhesive is defined wholly inadequately, since the shear rate is not given. Consequently, the skilled person is unable to reproduce the invention described in this disclosure.

An object of the present invention is to provide a method for producing an adhesive tape intended more particularly for wrapping cables, comprising an open textile carrier and a pressure-sensitive adhesive coated on one side thereof, where the pressure-sensitive adhesive does not strike through during coating and at the same time effective anchorage on the carrier is ensured.

This object is achieved by means of a method as recorded in the main claim. The dependent claims provide advantageous developments of the method.

The invention accordingly provides a method for producing an adhesive tape intended more particularly for wrapping cables, and comprising a textile carrier and a pressure-sensitive adhesive coated on one side thereof, the shear viscosity of the pressure-sensitive adhesive at a temperature of 25° C. during coating from dispersion being 200 to 100 000 Pa*s at a shear rate of 10⁻² s⁻¹ and 0.1 to 10 Pa*s at a shear rate of 100 s⁻¹.

The adhesive is a pressure-sensitive adhesive, in other words an adhesive which even under a relatively weak applied pressure allows permanent connection to virtually all substrates and which after use can be detached again substantially without residue from the substrate. At room temperature, a pressure-sensitive adhesive has a permanent pressure-sensitive adhesion effect, thus having a sufficiently low viscosity and a high tack, and so it wets the surface of the respective substrate even with low applied pressure. The bondability of the adhesive derives from its adhesive properties, and the redetachability from its cohesive properties.

The textile carrier, which has likewise already been preferred, is preferably a woven fabric, more preferably a woven polyester fabric.

As carrier material for the adhesive tape, it is possible to use all known textile carriers such as knits, scrims, tapes, braids, needlefelt textiles, felts, knitted fabrics (including warp knits and others) or nonwoven webs, the term “nonwoven web” referring at least to textile sheetlike structures as per EN 29092 (1988) and also to stitchbonded nonwovens and similar systems.

It is likewise possible to use woven and knitted spacer fabrics with lamination.

Spacer fabrics of these kinds are disclosed in EP 0 071 212 B1. Spacer fabrics are mat-like layer structures comprising a cover layer of a fibre or filament web, an underlayer and individual retaining fibres or bundles of such fibres between these layers, these fibres being distributed over the area of the layer structure, being needled through the particle layer and joining the cover layer and the underlayer to one another. As an additional although not mandatory feature, the retaining fibres in accordance with EP 0 071 212 B1 contain particles of inert minerals, such as sand, gravel or the like, for example.

The retaining fibres needled through the particle layer hold the cover layer and the underlayer at a distance from one another and are joined to the cover layer and the underlayer.

Nonwovens contemplated include, in particular, consolidated staple fibre webs, but also filament webs, meltblown webs and spunbonded webs, which generally require additional consolidation. Possible consolidation methods known for webs include mechanical, thermal and chemical consolidation. Whereas with mechanical consolidations the fibres are held together purely mechanically usually by entanglement of the individual fibres, by the interlooping of fibre bundles or by the stitching-in of additional threads, it is possible by thermal and by chemical techniques to obtain adhesive (with binder) or cohesive (binderless) fibre-fibre bonds. Given appropriate formulation and an appropriate process regime, these bonds may be restricted exclusively, or at least predominantly, to fibre nodal points, so that a stable, three-dimensional network is formed while nevertheless retaining the relatively loose, open structure in the web.

Webs which have proved to be particularly advantageous are those consolidated in particular by overstitching with separate threads or by interlooping.

Consolidated webs of this kind are produced for example on stitchbonding machines of the “Malimo” type from the company Karl Mayer, formerly Malimo, and can be obtained from companies including Techtex GmbH. A Malifleece is characterized in that a cross-laid web is consolidated by the formation of loops from fibres of the web.

The carrier used may also be a web of the Kunit or Multiknit type. A Kunit web is characterized in that it originates from the processing of a longitudinally oriented fibre web to form a sheetlike structure which has loops on one side and has loop feet or pile fibre folds on the other side, but possesses neither threads nor prefabricated sheetlike structures. A web of this kind as well has been produced for a relatively long time, for example on stitchbonding machines of the “Malimo” type from the company Karl Mayer. A further characterizing feature of this web is that, as a longitudinal-fibre web, it is able to absorb high tensile forces in the longitudinal direction. The characteristic feature of a Multiknit web relative to the Kunit web is that the web is consolidated on both the top and bottom sides by virtue of the double-sided needle punching. The starting product used for a Multiknit is generally one or two single-sidedly interlooped pile fibre nonwovens produced by the Kunit process. In the end product, both top sides of the nonwovens are shaped by means of interlooped fibres to form a closed surface, and are joined to one another by fibres which stand almost perpendicularly. An additional possibility is to introduce further needlable sheetlike structures and/or scatterable media.

Finally, stitchbonded webs as an intermediate are also suitable for forming a liner of the invention and an adhesive tape of the invention. A stitchbonded web is formed from a nonwoven material having a large number of stitches extending parallel to one another. These stitches are brought about by the stitching-in or stitchbonding of continuous textile threads. For this type of web, stitchbonding machines of the “Malimo” type from the company Karl Mayer are known.

Also particularly suitable are needlefelt webs. In a needlefelt web, a tuft of fibres is made into a sheetlike structure by means of needles provided with barbs. By alternate introduction and withdrawal of the needles, the material is consolidated on a needle bar, with the individual fibres interlooping to form a firm sheetlike structure. The number and configuration of the needling points (needle shape, penetration depth, double-sided needling) determine the thickness and strength of the fibre structures, which are in general lightweight, air-permeable and elastic.

Also particularly advantageous is a staple fibre web which is mechanically preconsolidated in the first step or is a wet-laid web laid hydrodynamically, in which between 2% and 50% by weight of the web fibres are fusible fibres, more particularly between 5% and 40% by weight of the web fibres.

A web of this kind is characterized in that the fibres are laid wet or, for example, a staple fibre web is preconsolidated by the formation of loops from fibres of the web by needling, stitching or air-jet and/or water-jet treatment.

In a second step, thermofixing takes place, with the strength of the web being increased again by the melting, or partial melting, of the fusible fibres.

For the utilization of nonwovens in accordance with the invention, the adhesive consolidation of mechanically preconsolidated or wet-laid webs is of particular interest, it being possible for said consolidation to take place by way of the addition of binder in solid, liquid, foamed or paste-like form. A great diversity of theoretical presentation forms is possible: for example, solid binders as powders for trickling in; as a sheet or as a mesh; or in the form of binding fibres. Liquid binders may be applied as solutions in water or organic solvents, or as a dispersion. For adhesive consolidation, binding dispersions are predominantly selected: thermosets in the form of phenolic or melamine resin dispersions, elastomers as dispersions of natural or synthetic rubbers or, usually, dispersions of thermoplastics such as acrylates, vinyl acetates, polyurethanes, styrene-butadiene systems, PVC, and the like, and also copolymers thereof. Normally the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” (Georg Thieme Verlag, Stuttgart, 1982) or “Textiltechnik-Vliesstofferzeugung” (Arbeitgeberkreis Gesamttextil, Eschborn, 1996).

For mechanically preconsolidated webs which already possess sufficient composite strength, the single-sided spray application of a binder is appropriate for producing specific changes in the surface properties.

Such a procedure not only is sparing in its use of binder but also greatly reduces the energy requirement for drying. Since no squeeze rolls are required and the dispersions remain predominantly in the upper region of the nonwoven, unwanted hardening and stiffening of the web can be largely prevented.

For sufficient adhesive consolidation of the web carrier, the addition of binder in the order of magnitude of 1% to 50%, more particularly 3% to 20%, based on the weight of the fibre web, is generally required.

The binder may be added as early as during the manufacture of the web, in the course of mechanical preconsolidation, or else in a separate process step, which may be carried out in-line or off-line. Following the addition of binder, it is necessary temporarily to generate a condition for the binder in which the binder becomes adhesive and adhesively connects the fibres—this may be achieved during the drying, for example, of dispersions, or else by means of heating, with further possibilities for variation existing by way of areal or partial application of pressure. The binder may be activated in known drying tunnels, given an appropriate selection of binder, or else by means of infrared radiation, UV radiation, ultrasound, high-frequency radiation or the like. For the subsequent end use it is sensible, though not absolutely necessary, for the binder to have lost its tack following the end of the web production process. It is advantageous that, as a result of thermal treatment, volatile components such as fibre assistants are removed, giving a web having favourable fogging values, so that when a low-fogging adhesive is used, it is possible to produce an adhesive tape having particularly favourable fogging values; accordingly, the liner as well has a very low fogging value.

By fogging (see DIN 75201 A) is meant the effect where, under unfavourable conditions, compounds of low molecular mass may outgas from the adhesive tapes and condense on cold parts. As a result of this it is possible, for example, for vision through the windscreen to be adversely affected.

A further special form of adhesive consolidation involves activating the binder by partial dissolution or partial swelling. In this case it is also possible in principle for the fibres themselves, or admixed speciality fibres, to take over the function of the binder. Since, however, such solvents are objectionable on environmental grounds, and/or are problematic in their handling, for the majority of polymeric fibres, this process is not often employed.

Advantageously and at least in regions, the carrier may have a single-sidedly or double-sidedly polished surface, preferably in each case a surface polished over the whole area. The polished surface may be chintzed, as elucidated in detail in EP 1 448 744 A1, for example.

Furthermore, the carrier may be compacted by calendering on a roll mill. The two rolls preferably run in opposite directions and at the same peripheral speed, causing the carrier to be pressed and compacted.

If there is a difference in the peripheral speed of the rolls, then the carrier is additionally polished.

Starting materials for the carrier material for the adhesive tape are more particularly (manmade) fibres (staple fibre or continuous filament) made from synthetic polymers, also called synthetic fibres, made from polyester, polyamide, polyimide, aramid, polyolefin, polyacrylonitrile or glass, (manmade) fibres made from natural polymers such as cellulosic fibres (viscose, Modal, Lyocell, Cupro, acetate, triacetate, Cellulon), such as rubber fibres, such as plant protein fibres and/or such as animal protein fibres and/or natural fibres made of cotton, sisal, flax, silk, hemp, linen, coconut or wool. The present invention, however, is not confined to the materials stated; it is instead possible, as evident to the skilled person without having to take an inventive step, to use a multiplicity of further fibres in order to produce the carrier.

Likewise suitable, furthermore, are yarns fabricated from the fibres specified.

In the case of woven fabrics or scrims, individual threads may be produced from a blend yarn, and thus may have synthetic and natural constituents. Generally speaking, however, the warp threads and the weft threads are each formed of a single kind.

The warp threads and/or the weft threads here may in each case be composed only of synthetic threads or only of threads made from natural raw materials—in other words, of a single kind.

With particular preference the woven fabric has the following features:
number of warp threads in the range from 30 to 60 per cm,
number of weft threads in the range from 23 to 50 per cm,
linear yarn density in warp direction from 40 to 180 dtex and/or
linear yarn density in weft direction from 100 to 400 dtex.

Weft insertion may take the form of single and/or multiple weft.

The woven fabric may have a plain weave, twill or satin weave configuration.

The woven fabric is preferably calendered at temperatures in the range from 80 to 250° C. and under a high pressure (greater than or equal to 400 bar, preferably 450 bar, or at 170 N/mm), with consequent compaction of the surface. As a result of this measure, the air permeability is lowered to below a level of 200 l/m²*s in accordance with DIN EN ISO 9237 (200 Pa differential pressure in the case of technical sheetlike structures, 20 cm² test area). Particularly preferred are woven fabric constructions which allow values of below 130 l/m²*s.

Generally speaking, in accordance with one particularly preferred embodiment of the invention, the air permeability of the woven fabric carrier is below a figure of 200 l/m²*s in accordance with DIN EN ISO 9237 (200 Pa differential pressure in the case of technical sheetlike structures, 20 cm² test area), more preferably below 130 l/m²*s.

In the case of woven fabric constructions with relatively high air permeability, it is additionally appropriate, in order to improve the coating qualities, to apply an impregnation, which is applied preferably as an aqueous dispersion.

The woven fabric is preferably black, with the yarns (filaments) being spun-dyed.

With the parameters stated above, at least full-area wetting of the textile carrier, and usually, indeed, sinking-in of the adhesive, is achieved, without significant strikethrough. Since some of the coated composition penetrates the pores of the textile carrier, the actual adhesive coatweight does not match that effectively available for bonding. The effective adhesive coatweight, in other words that available for bonding, is considered to be that which is located above the fabric plane of the adhesive-coated side. Accordingly, secure adhesive anchorage is achieved, and at the same time adverse effects such as increased unwind force or disruptions to the coating operation by struck-through adhesive are avoided.

Where the effective coatweight is lower than the actual coatweight, an unexpected, but usually desired, effect may occur, which facilitates the processing of the adhesive tape in the case of cable jacketing: the adhesive tape becomes manually tearable from the side, since the adhesive located within the textile structure fixes the warp threads and weft threads of the fabric against slippage. In the case of untreated fabrics, this very slippage, during an attempt at tearing, provides an increasing toughness, which greatly hinders manual tearability, if not making it completely impossible. Preference is therefore given to woven fabrics having a linear yarn density of less than 90 dtex.

The pressure-sensitive adhesive (PSA) consists preferably of an aqueous acrylate dispersion, in other words of a polyacrylic ester dispersed finely in water and having pressure-sensitive adhesive properties, as are described, for example, in the Handbook of Pressure Sensitive Technology by D. Satas.

Acrylate PSAs are typically radically polymerized copolymers of alkyl esters of acrylic or methacrylic acid with C₁ to C₂₀ alcohols, such as, for example, methyl acrylate, ethyl(meth)acrylate, n-butyl(meth)acrylate, tert-butyl(meth)acrylate, cyclohexyl(meth)acrylate, 2-ethylhexyl(meth)acrylate, n-octyl(meth)acrylate, isooctyl(meth)acrylate, n-decyl(meth)acrylate, n-dodecyl(meth)acrylate, tetradecyl(meth)acrylate, lauryl(meth)acrylate, oleyl(meth)acrylate, palmityl(meth)acrylate and stearyl(meth)acrylate, in addition to further (meth)acrylic esters such as isobornyl(meth)acrylate, benzyl(meth)acrylate, phenyl(meth)acrylate and 2-bromoethyl(meth)acrylate, alkoxyalkyl(meth)acrylates such as ethoxyethyl(meth)acrylate. Also included are esters of ethylenically unsaturated dicarboxylic and tricarboxylic acids and anhydrides, such as ethyl maleate, dimethyl fumarate and ethyl methyl itaconate. Likewise included are vinylaromatic monomers such as, for example, styrene, vinyltoluene, methylstyrene, n-butylstyrene and decylstyrene.

Further possible monomers for achieving the advantageous properties are vinyl esters of carboxylic acids containing up to 20 carbon atoms, such as vinyl acetate or vinyl laurate, vinyl ethers of alcohols containing up to 10 carbon atoms, such as vinyl methyl ether or vinyl isobutyl ether, vinyl halides such as vinyl chloride or vinylidene dichloride, nitriles such as acrylonitrile or methacrylonitrile, acid amides such as acrylamide or methacrylamide, and unsaturated hydrocarbons having 2 to 8 carbon atoms such as ethylene, propene, butadiene, isoprene, 1-hexene or 1-octene.

Suitable for influencing the physical and optical properties of the PSA, as crosslinker monomers, are polyfunctional, ethylenically unsaturated monomers. Examples of such are divinylbenzene, alkyl diacrylates such as 1,2-ethylene glycol diacrylate, 1,4-butanediol diacrylate, 1,6-hexanediol diacrylate, 1,8-octanediol diacrylate or 1,12-dodecanediol diacrylate, triacrylates such as trimethylolpropane triacrylate and tetraacrylates such as pentaerythritol tetraacrylate. The group of the polyfunctional monomers also includes UV-crosslinkable monomers such as, for example, (meth)acrylate-functionalized derivatives of benzophenone or of benzoin.

Another group of monomers are those which generate a latent crosslinking potential in the polymer and which, after the drying of the adhesive, lead spontaneously (frequently under catalysis) to the construction of a network. One such monomer is, for example, glycidyl methacrylate, whose oxirane ring with hydroxyl functions or, more particularly, carboxylate functions leads to a covalent bond, with ring opening. This reaction takes place at a faster rate in the presence of zinc ions or, particularly in the presence of carboxyl functions, amines.

In order to achieve pressure-sensitive adhesive properties it is necessary for the processing temperature of the adhesive to be above its glass transition temperature, in order to have viscoelastic properties.

Typical particle sizes of the dispersed polymer range from 20 nm up to 10 μm. The polymer dispersion is prepared by the process of the emulsion polymerization of acrylate monomers and possibly further ethylenically unsaturated monomers. Descriptions of this process are given for example in “Emulsion Polymerization and Emulsion Polymers”—Peter A. Lovell and Mohamed S. El-Aasser—Wiley-VCH 1997—ISBN 0-471-96746-7 or in EP 1 378 527 B1.

The shear viscosities of commercial dispersions are generally below those of the method of the invention. In order to obtain the necessary shear viscosities, use is generally made of rheological additives, also called thickeners.

In principle a distinction is made here between organic and inorganic rheological additives.

The organic thickeners divide in turn into two key principles of action: (a) the thickening of the aqueous phase, i.e. non-associative, and (b) formation of associates between thickener molecule and particles, in some cases with inclusion of the stabilizers (emulsifiers).

Representatives of the first group of substance are water-soluble polyacrylic acids and polycoacrylic acids which in a basic medium form polyelectrolytes having a high hydrodynamic volume. The skilled person also refers to these for short as ASEs (alkali-swellable emulsions). They are distinguished by high resting shear viscosities and a high level of shear thinning. Another class of substance are the modified polysaccharides, more particularly cellulose ethers such as carboxymethylcellulose, 2-hydroxyethylcellulose, carboxymethyl-2-hydroxyethylcellulose, methylcellulose, 2-hydroxyethylmethylcellulose, 2-hydroxyethylethylcellulose, 2-hydroxypropylcellulose, 2-hydroxypropylmethylcellulose, 2-hydroxybutylmethylcellulose. Additionally included in this class of substance are less widespread polysaccharides such as starch derivatives and specific polyethers.

The group of the associative thickeners are in principle block copolymers having a water-soluble middle block and hydrophobic end blocks, the end blocks interacting with the particles or with themselves and so forming a three-dimensional network with inclusion of the particles. Typical representatives are familiar to the skilled person in the form of HASE (hydrophobically modified alkali-swellable emulsion), HEUR (hydrophobically modified ethyleneoxide urethane) or HMHEC (hydrophobically modified hydroxyethyl cellulose). In the case of the HASE thickeners, the middle block is an ASE, and the end blocks are long, hydrophobic alkyl chains usually coupled on via polyethylene oxide bridges. In the case of the HEUR, the water-soluble middle block is a polyurethane, while in the case of HMHEC it is a 2-hydroxyethylcellulose.

The nonionic HEUR and HMHEC in particular are largely insensitive to pH.

Depending on structure, the associative thickeners produce, to a greater or lesser extent, a Newtonian (shear rate-independent) or pseudoplastic (shear-liquefying) flow behaviour. In some cases they also exhibit a thixotropic character—that is, in addition to the viscosity being dependent on the shearing force, it is also dependent on time.

The inorganic thickeners are mostly phyllosilicates of natural or synthetic origin, examples being hectorites and smectites. In contact with water, the individual layers part from one another. As a result of different charges on surfaces and edges of the platelets, they form, when at rest, a space-filling house-of-cards structure, resulting in high resting shear viscosities through to yield points. On shearing, the house-of-cards structure collapses and a marked drop in the shear viscosity is observed. Depending on charge, concentration and geometric dimensions of the platelets, the development of structure may take some time, and so with inorganic thickeners of this kind it is also possible for thixotropy to be obtained.

The thickeners can in some cases be stirred directly into the adhesive dispersion or in some cases are advantageously prediluted or predispersed in water beforehand. Typical use concentrations are 0.1% to 5% by weight, based on the solids.

Suppliers of thickeners include, for example, OMG Borchers, Omya, Byk Chemie, Dow Chemical Company, Evonik, Rockwood or Münzing Chemie.

For the purpose of improving the adhesive properties, the acrylate dispersion may be blended with tackifiers.

Suitable tackifiers, also referred to as tackifier resins, are in principle all known classes of compound. Examples of tackifiers are hydrocarbon resins (for example polymers based on unsaturated C₅ or C₉ monomers), terpene-phenolic resins, polyterpene resins based on raw materials such as, for example, α- or β-pinene, aromatic resins such as coumarone-indene resins or resins based on styrene or α-methylstyrene such as rosin and its derivatives, as for example disproportionated, dimerized or esterified rosin, examples being reaction products with glycol, glycerol or pentaerythritol, to name but a few. Preference is given to resins without readily oxidizable double bonds such as terpene-phenolic resins, aromatic resins and more preferably resins prepared by hydrogenaton, such as, for example, hydrogenated aromatic resins, hydrogenated polycyclopentadiene resins, hydrogenated rosin derivatives or hydrogenated polyterpene resins.

Resins based on terpene-phenols and rosin esters are preferred. Likewise preferred are tackifier resins having a softening point of more than 80° C. in accordance with ASTM E28-99 (2009). Particularly preferred are resins based on terpene-phenols and rosin esters having a softening point of more than 90° C. in accordance with ASTM E28-99 (2009). The resins are appropriately used in dispersion form. In this way they can be readily mixed in finely divided form with the polymer dispersion.

Typical amounts for use are 10 to 100 parts by weight, based on the solids.

For a further improvement in cable compatibility, the adhesive formulation may optionally be blended with light stabilizers or with primary and/or secondary ageing inhibitors. Ageing inhibitors that can be used are products based on sterically hindered phenols, phosphites, thiosynergists, sterically hindered amines or UV absorbers.

Preference is given to using primary antioxidants such as, for example, Irganox 1010 or Irganox 254, alone or in combination with secondary antioxidants such as, for example, Irgafos TNPP or Irgafos 168.

The ageing inhibitors here can be used in any desired combination with one another, with particularly good ageing inhibition being displayed by mixtures of primary and secondary antioxidants in combination with light stabilizers such as Tinuvin 213, for example.

Having proved to be especially advantageous are ageing inhibitors in which a primary antioxidant is united with a secondary antioxidant in one molecule. These ageing inhibitors are cresol derivatives whose aromatic ring is substituted at two arbitrary, different locations, preferably in ortho- and meta-position to the OH group, by thioalkyl chains, it being possible for the sulphur atom also to be joined via one or more alkyl chains to the aromatic ring of the cresol moiety. The number of carbon atoms between the aromatic moiety and the sulphur atom can be between 1 and 10, preferably between 1 and 4. The number of carbon atoms in the alkyl side chain can be between 1 and 25, preferably between 6 and 16. Particularly preferred in this context are compounds of the 4,6-bis(dodecylthiomethyl)-o-cresol, 4,6-bis(undecylthiomethyl)-o-cresol, 4,6-bis(decylthiomethyl)-o-cresol, 4,6-bis(nonylthiomethyl)-o-cresol or 4,6-bis(octylthiomethyl)-o-cresol type. Ageing inhibitors of these kinds are available, for example, from Ciba Geigy under the name Irganox 1726 or Irganox 1520.

The amount of the ageing inhibitor or ageing inhibitor package added ought to be situated within a range between 0.1% and 10% by weight, preferably within a range between 0.2% and 5% by weight, more preferably within a range between 0.5% and 3% by weight, based on the total solids content.

Preference is given to the presentation form of a dispersion for particularly easy mixablity with the adhesive dispersion. Alternatively, liquid ageing inhibitors can also be incorporated directly into the dispersion, in which case the step of incorporation ought to be followed by a standing time of a number of hours, in order to allow homogeneous distribution in the dispersion or the takeup of the ageing inhibitor into the dispersion particles. A further alternative is to add an organic solution of the ageing inhibitors to the dispersion.

Suitable concentrations are situated in the range from 0.1 up to 5 parts by weight, based on the solids.

For improving the processing properties, the adhesive formulation can additionally be blended with customary process assistants such as rheological additives (thickeners), defoamers, deaerating agents, wetting agents or flow control agents. Suitable concentrations are situated in the range from 0.1 up to 5 parts by weight, based on the solids.

Fillers (reinforcing or non-reinforcing) such as silicon dioxides (spherical, acicular, platelet-shaped or irregular such as the fumed silicas), glass in the form of solid or hollow beads, microballoons, calcium carbonates, zinc oxides, titanium dioxides, aluminium oxides or aluminium oxide hydroxides may serve both for adjusting the processing properties and for adjusting the technical adhesive properties. Suitable concentrations are situated in the range from 0.1 up to 20 parts by weight, based on the solids.

The method of the invention for producing the adhesive tape for jacketing cables also includes the coating of the textile carrier directly with the dispersion in one or more operations carried out one after another. The method envisages direct coating of the carrier. Application techniques contemplated are those familiar to the skilled person, such as wire doctor (Meyer bar), coating bar, comma bar, coating knife with V-shaped or circular profile, calender roll or engraved roll application, nozzle coating, twin-chamber doctor blade or multiple cascade die.

Drying may take place in tunnel dryers, or in suspension using hot air or IR emitters, there being no intention that this recitation should have a restrictive effect. The skilled person is familiar with other such techniques, without them being listed here in detail.

The adhesive tape may ultimately have a liner material, with which the one or two layers of adhesive are lined before use. Suitable liner materials also include all of the materials set out comprehensively above.

It is preferred to use a non-linting material such as a polymeric film or a well-sized, long-fibre paper.

If the adhesive tape described is to be of low flammability, this quality can be achieved by adding flame retardants to the carrier and/or to the adhesive. These retardants may be organobromine compounds, if required with synergists such as antimony trioxide, although, with regard to the absence of halogen from the adhesive tape, preference will be given to using red phosphorus, organophosphorus compounds, mineral compounds or intumescent compounds such as ammonium polyphosphate, alone or in conjunction with synergists.

The general expression “adhesive tape” in the context of this invention encompasses all sheetlike structures such as two-dimensionally extended sheets or sheet sections, tapes with extended length and limited width, tape sections and the like, and also, lastly, diecuts or labels.

The adhesive tape may be produced in the form of a roll, in other words rolled up onto itself in the form of an archimedean spiral.

Applied to the reverse of the adhesive tape may be a reverse-face varnish, in order to exert a favourable influence on the unwind properties of the adhesive tape wound into the archimedean spiral. This reverse-face varnish may for this purpose be furnished with silicone compounds or fluorosilicone compounds and also with polyvinylstearylcarbamate, polyethyleneiminestearylcarbamide or organofluorine compounds as abhesive substances.

The adhesive may be applied in the longitudinal direction of the adhesive tape, in the form of a stripe, the width of the stripe being lower than that of the carrier of the adhesive tape.

Depending on the particular utility, there may also be a plurality of parallel stripes of the adhesive coated on the carrier material.

The position of the stripe on the carrier is freely selectable, with preference being given to an arrangement directly at one of the edges of the carrier.

The adhesive is preferably applied over the full area to the carrier.

Provided on the adhesive coating of the carrier there may be at least one stripe of a covering, extending in the longidutinal direction of the adhesive tape and covering between 20% and 90% of the adhesive coating.

The stripe preferably covers in total between 50% and 80% of the adhesive coating. The degree of coverage is selected according to the application and to the diameter of the cable harness.

The percentage figures indicated relate to the width of the stripes of the covering in relation to the width of the carrier.

In accordance with one preferred embodiment of the invention there is precisely one stripe of the covering present on the adhesive coating.

The position of the stripe on the adhesive coating is freely selectable, with preference being given to an arrangement directly at one of the longitudinal edges of the carrier. In this way an adhesive stripe is produced which extends in the longitudinal direction of the adhesive tape and finishes at the other longitudinal edge of the carrier.

Where the adhesive tape is used for jacketing a cable loom, by the adhesive tape being passed in a helicoidal movement around the cable loom, the wrapping of the cable loom may be accomplished by bonding the adhesive of the adhesive tape only to the adhesive tape itself, with the substrate not coming into contact with any adhesive.

The cable loom jacketed in this way has a very high flexibility, as a result of the absence of fixing of the cable by any adhesive. Consequently the flexibility of said cable loom on installation—particularly in narrow passages or sharp bends—is significantly increased.

If a certain degree of fixing of the adhesive tape on the substrate is desired, the jacketing may be accomplished by bonding part of the adhesive stripe to the adhesive tape itself and another part to the substrate.

In accordance with another advantageous embodiment, the stripe is applied centrally on the adhesive coating, thereby producing two adhesive stripes extending on the longitudinal edges of the carrier in the longitudinal direction of the adhesive tape.

For the secure and economic application of the adhesive tape in said helicoidal movement around the cable loom, and to counter the slipping of the resultant protective wrapping, the two adhesive stripes each present on the longitudinal edges of the adhesive tape are advantageous, especially if one stripe, which is usually narrower than the second stripe, serves as a fixing aid and the second, broader stripe serves as a fastener. In this way, the adhesive tape is bonded to the cable in such a way that the cable harness is secured against slipping but is nevertheless of flexible design.

In addition there are embodiments in which more than one stripe of the covering is applied to the adhesive coating. Where reference is made only to one stripe, the skilled person reads this, conceptually, as accommodating the possibility that there may well be two or more stripes covering the adhesive coating at the same time.

On account of the preferred acrylate adhesive basis, the adhesive tape produced with the method of the invention is outstandingly suitable for the wrapping of cables, including for the high temperature classes T3 and T4. Unwinding is easy, since no adhesive has gone onto the reverse during coating, and at the same time the adhesive is anchored so firmly that there are no instances of transfer. Under certain boundary conditions affecting the woven fabric, it is easily tearable by hand and makes processing easier when producing cable harnesses, as a result of the lack of need for tools for separating off individual lengths. Facilitated manual tearability of this kind is obtained above all through the choice of a fine warp thread of below 90 dtex in density. In order to avoid the warp threads shifting onto one another during the tearing procedure, it is vital that the individual yarns in the fabric are adequately fixed, as by a tenter frame operation at high temperatures, for example. Further fixing can be achieved through coating/impregnation with aqueous dispersions, which on account of capillary effects are able to penetrate deep into the woven-fabric interstices and into the yarn itself, in other words between the individual filaments. The combination of conventional fixing in a tenter frame and coating with an aqueous dispersion achieves an optimum manual tearability. An example in this context is a woven fabric having a construction of 34 threads/cm with 84 dtex density in warp direction and 28 threads/cm with 167 dtex in weft direction. After fixing in a tenter frame, this fabric does not have optimum manual tearability, and has a tearing strength of 8 to 10 N in accordance with the established AFERA 4007 method. Coating with an acrylate dispersion allows this figure to be lowered to a level of 4 to 6 N, and this is reflected in very good tearability.

Furthermore, it is advantageously suitable for the jacketing of elongate material such as, more particularly, cable harnesses in motor vehicles, with the adhesive tape being passed in a helical line around the elongate material, or the elongate material being able to be wrapped in axial direction by the tape.

On account of the outstanding suitability of the adhesive tape, it can be used in a jacket that consists of a covering, where, at least in one edge region of the covering, the self-adhesive tape is present, and is bonded on the covering in such a way that the adhesive tape extends over one of the longitudinal edges of the covering, and preferably in an edge region which is narrow by comparison with the width of the covering.

One such product and also optimized embodiments thereof are disclosed in EP 1 312 097 A1. EP 1 300 452 A2, DE 102 29 527 A1 and WO 2006 108 871 A1 show ongoing developments for which the adhesive tape of the invention is likewise very suitable. The adhesive tape of the invention may also find use in a method of the kind disclosed by EP 1 367 608 A2.

Finally, EP 1 315 781 A1 and DE 103 29 994 A1 describe embodiments of adhesive tapes of a kind also possible for the adhesive tape of the invention.

The purpose of the text below is to illustrate the adhesive tape in more detail using a figure, without wishing thereby to bring about a restriction of whatever kind.

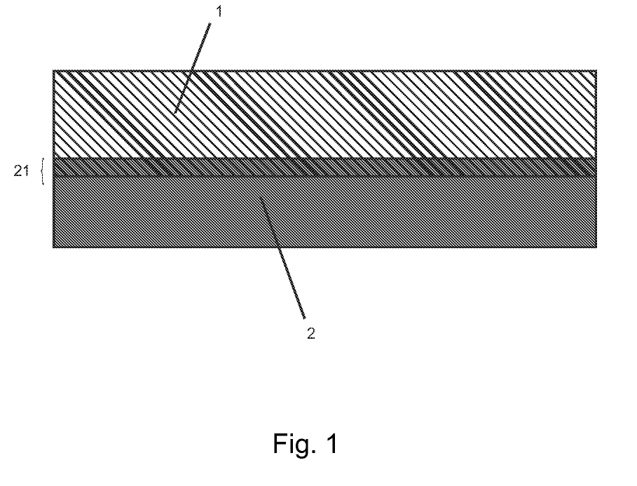

FIG. 1 Illustrates a cross-sectional view of an adhesive tape produced by a method in an embodiment.

Shown in FIG. 1, in a section in the transverse direction (transverse section), is the adhesive tape, consisting of a woven fabric carrier 1, on one side of which a layer of a self-adhesive coating 2 based on an acrylate dispersion is applied.

The adhesive has sunk into the carrier to an extent of 20%, and this produces optimum anchorage and at the same time improves the manual tearability of the carrier.

### EXAMPLES

For the purpose of illustrating the invention, the method was carried out in accordance with the following scheme:

Coating

Coating took place on a laboratory coating unit with a web width of 30 cm. The essential functional components of this unit are the unwinding of the uncoated carrier bale, the applicator for the adhesive for achieving a defined wet-film thickness, a floating nozzle tunnel dryer having four individually temperature-controllable temperature zones 5 m long, and a winder for winding up the coated and dried product.

The applicator mechanism used was a coating knife with a V-shaped profile, which was arranged radially above a coating roll rotating in the same direction as the web, the carrier being passed over this roll (knife-over-roll process). The distance between the fabric to be coated and the bottom edge of the coating knife was set so as to result, after drying, in the desired weight per unit area of the pressure-sensitive adhesive (PSA) in accordance with the examples.

A variant available was an applicator using the technology of an air knife. In contrast to the knife-over-roll process, there is no coating roll here. The coating knife is driven on contact with the carrier, and so the wet application rate is governed by the web tension.

The zones of the dryer were temperature-controlled as follows:

Zone 1: 80° C., Zone 2: 80° C., Zone 3: 90° C., Zone 4: 110° C.

The web speed was 4 m/min.

The wound, adhesive-coated and dried bale was processed on a finishing machine, by scissor slitting, into rolls with a length of 25 m and a width of 20 mm on 1.5 inch cardboard cores.

As exemplary carriers, two black-coloured woven polyester fabrics were employed:

Fabric 1:

Linear yarn density 167 dtex, threadcount warp 48.5 1/cm, threadcount weft 23 1/cm. Calendering took place at 100° C. under a pressure of 200 N/mm in the roll nip, or 478 bar. The air permeability is below 180 l/m²*s.

Fabric 2:

Warp thread linear density 84 dtex, warp threadcount 34 1/cm,

Weft thread linear density 167 dtex, weft threadcount 28 1/cm;

Calendering took place at 220° C. under a pressure of 230 N/mm in the roll nip, or 550 bar.

Fabric 3:

Like fabric 2, but with calendering at 100° C. under a pressure of 200 N/mm in the roll nip, or 478 bar.

As a commercially customary PSA dispersion, an acrylate dispersion with a 69% solids content was used (Acronal V215 from BASF).

Commercially customary thickeners used were as follows:

| Name | Manufacturer | Type | Characteristic |
|---|---|---|---|
| Acrysol TT615 ER | Dow | HASE | strongly pseudoplastic |
| Acrysol RM-12W | Dow | HEUR | strongly pseudoplastic |
| Borchigel 0625 | OMG Borchers | HEUR | pseudoplastic |
| Tafigel PUR 41 | Munzing Chemie | HEUR | pseudoplastic |

Before being mixed into the acrylate dispersion, the thickeners were diluted with distilled water in a 1:1 ratio (thereby halving the solids content), in order to improve their homogeneous incorporation into the acrylate dispersion. For incorporation, the acrylate dispersion in supply form was stirred with an anchor stirrer at 200 rpm and introduced into the vortex of the prediluted thickeners. For homogenization, stirring was continued for 10 minutes more following the addition. Prior to coating, the composition was left to stand for 24 hours for air to escape.

Determination of the Shear Viscosity

The shear viscosity was measured using a rheometer with cone/plate geometry (DSR 200 N from Rheometric Scientific) at 25° C. A shear stress sweep from 0.1 to 4700 Pa was run, with 10 measurement points per decade.

Assessment Criteria

The criteria for assessment for an application-compatible method are as follows:
adhesive anchorage on the carrier on unwind
unwind force

Implementation of the Tests

The tests were carried out on rolls 25 m in length and 20 mm in width, which had been stored at 40° C. for 14 days beforehand in order to emphasize more clearly the test outcomes.

Adhesive Anchorage on the Carrier on Unwind

The anchorage of the adhesive on the carrier is compatible with the application when during unwind there is no transfer observed of the PSA to the reverse of the adhesive tape. For this purpose, the roll is unwound at speeds of 0.3 m/min and 30 m/min, and the reverse of the carrier, in other words the side facing away from the adhesive, is inspected for residues of adhesive. Residues of adhesive can be seen very clearly against the black fabric.

The outcome “no adhesive residues” is compatible with the application and is given a rating of “1”. Any visible residues of adhesive attract a rating of “0”.

Unwind Force

If the viscosity of the adhesive dispersion is not harmonized with the construction of the woven fabric, the adhesive dispersion may strike through the carrier in the course of the coating operation, with the consequence that adhesive is also present on the reverse of the carrier, in other words on the side facing away from the adhesive. Since during winding of the adhesive tape roll there is adhesive/adhesive contact, the bond strength increases perceptibly and rapidly gets beyond a tolerable level. The tolerable level is mandated by the automotive standard LV312, according to which the unwind force of a roll of adhesive tape for cable jacketing, at a take-off speed of 30 m/min, is to be between 3 and 9 N/cm.

If the value lies within this range, then strikethrough of the adhesive is negligible and is given a rating of “1”. Values above this range receive a rating of “0+”.

In the event of massive strikethrough of the adhesive, manual unwind is barely still possible. In that case there is full-blown blocking of the roll, and in some cases the adhesive undergoes transfer to the reverse. In the presence of this defect, the unwind force is marked “0−”.

For the performance judgement to be passed, both criteria must receive scoring of “1”.

Table 1 lists the formulas of the dispersion adhesive formulations. The numbers here indicate the thickener content in per cent based on the solids.

TABLE 1

| Thickener | Formulation | | | | |
|---|---|---|---|---|---|
| identification | 1 | 2 | 3 | 4 | 5 |
| Acrysol TT 615 ER | 0.16 | — | — | — | — |
| Acrysol RM-12W | — | 0.16 | — | — | — |
| Borchigel 0625 | — | — | 0.20 | — | — |
| Tafigel PUR 41 | — | — | — | — | 0.05 |

Table 2 indicates the shear viscosities in Pa*s of example formulations 1 to 5 at shear rates of 0.01 s⁻¹ and 100 s⁻¹.

TABLE 2

| | Shear viscosities of formulation in Pa * s | | | | |
|---|---|---|---|---|---|
| Shear rate | 1 | 2 | 3 | 4 | 5 |
| 0.01 s⁻¹ | 3000 | 1000 | 500 | 40 | 80 |
| 100 s⁻¹ | 3 | 1.5 | 4 | 0.5 | 2 |

In accordance with the coating method described above, the adhesive tape constructions compiled in Table 3, as inventive and comparative examples, were produced on fabrics 1 and 2 using the adhesive formulations 1 to 5:

TABLE 3

| | Formulation | | | | | |
|---|---|---|---|---|---|---|
| | 1 | 1 | 2 | 3 | 4 | 5 |
| Fabric 1 | Inventive | Inventive | Inventive | In- | Com- | Com- |
| | example | example | example | ventive | parative | parative |
| | IE1 | IE2* | IE3 | example | example | example |
| | | | | IE4 | CE1 | CE2 |
| Fabric 2 | Com- | | | | | |
| | parative | | | | | |
| | example | | | | | |
| | CE3 | | | | | |
| Fabric 3 | Com- | | | | | |
| | parative | | | | | |
| | example | | | | | |
| | CE4 | | | | | |

*Deviating from the others in mode of production; explanation in text.

For all of the inventive and comparative examples with the exception of inventive example IE2, the coating slot was set such that drying resulted in a weight per unit area for the coating of 100 g/m², with a tolerance of ±3 g/m².

In the case of inventive example IE2, a two-step process variant was employed: in a first step, the air knife applicator was used to apply a weight per unit area of dried adhesive of around 20 g/m² to the fabric. After this coating step, the fabric did not exhibit any tack. The effective coatweight was therefore zero; the entire adhesive had sunk into the carrier.

In the second step, the pre-coated fabric was coated using the knife-over-roll process with a further approximately 80 g/m² of adhesive, to give, after drying, a total weight per unit area of the coating of 100 g/m², with a tolerance of ±3 g/m².

Table 4 shows the results of the tests for the criteria of “adhesive anchorage on the carrier on unwind” and “unwind force”.

TABLE 4

| | Inventive | | | | Comparative | | | |
|---|---|---|---|---|---|---|---|---|
| | examples | | | | examples | | | |
| | IE1 | IE2 | IE3 | IE4 | CE1 | CE2 | CE3 | CE4 |
| Adhesive | 1 | 1 | 1 | 1 | 1 | 1 | 1 | 1 |
| anchorage on | | | | | | | | |
| carrier on | | | | | | | | |
| unwind | | | | | | | | |
| Unwind force | 1 | 1 | 1 | 1 | 0+ | 0+ | 0+ | 0− |

Only in the case of the adhesive tapes with woven fabric carrier that were produced by the method of the invention is it possible to realise both key criteria for a functioning adhesive tape. The comparative examples, in contrast, are unsuitable. In the case of comparative examples 1 to 3, the favourable effect of calendering is evident relative to comparative example 4.

However, calendering alone does not result in the desired coatability of the carrier, which is an interplay of calendering and woven-fabric construction.

Thinner and/or more open woven-fabric constructions therefore require more intense calendering than thick, closed carriers.

We claim:

1. A method comprising:
producing an adhesive tape comprising a textile carrier and a pressure-sensitive adhesive coated on one side thereof, wherein a shear viscosity of the pressure-sensitive adhesive, at a temperature of 25° C. during coating from dispersion, is 200 to 100 000 Pa*s at a shear rate of 10⁻² s⁻¹ and 0.1 to 10 Pa*s at a shear rate of 100 s⁻¹.

2. The method according to claim 1, wherein the textile carrier is a woven fabric.

3. The method according to claim 1, wherein the textile carrier is a woven fabric which has the following features:
number of warp threads in the range from 30 to 60 per cm,
number of weft threads in the range from 23 to 50 per cm,
linear yarn density in warp direction from 40 to 180 dtex and/or
linear yarn density in weft direction from 100 to 400 dtex.

4. The method according to claim 1, wherein the textile carrier is a woven fabric that is calendered at temperatures in the range from 80 to 250° C. and under a pressure of greater than or equal to 400 bar or at 170 N/mm.

5. The method according to claim 1, wherein the textile carrier is a woven fabric, the air permeability being below a value of 200 l/m²*s according to DIN EN ISO 9237 (200 Pa differential pressure for technical sheetlike structures, 20 cm² test area).

6. The method according to claim 1, wherein the adhesive is an aqueous acrylate dispersion.

7. The method according to claim 6, wherein the aqueous acrylate dispersion is prepared by the process of emulsion polymerization.

8. The method according to claim 1, wherein rheological additives are added to the pressure-sensitive adhesive.

9. The method according to claim 1, wherein the pressure-sensitive adhesive further comprises one or more tackifier resins having a softening point of more than 80° C. according to ASTM E28-99 (2009).

10. The method according to claim 1, wherein the textile carrier is a woven polyester fabric.

11. The method according to at least one of claim 1, wherein the textile carrier is a woven fabric that is calendered at temperatures in the range from 80 to 250° C. and under a pressure of greater than or equal to 450 bar.

12. The method according to claim 1, wherein the textile carrier is a woven fabric, the air permeability being below a value of 130 l/m²*s according to DIN EN ISO 9237 (200 Pa differential pressure for technical sheetlike structures, 20 cm² test area).

13. The method according to claim 1, wherein the pressure-sensitive adhesive further comprises one or more tackifier resins based on terpene phenols and/or rosin esters with a softening point of more than 90° C. according to ASTM E28-99 (2009).

14. A method comprising:
producing an adhesive tape comprising a textile carrier and a pressure-sensitive adhesive coated on one side thereof, wherein a shear viscosity of the pressure-sensitive adhesive, at a temperature of 25° C. during coating from dispersion, is 200 to 100 000 Pa*s at a shear rate of 10⁻² s⁻¹ and 0.1 to 10 Pa*s at a shear rate of 100 s⁻¹, and
wrapping the adhesive tape around one or more cables.
